(19) United States
(12) Patent Application Publication
(10) Pub. No.: US 2010/0193594 A1
(43) Pub. Date: Aug. 5, 2010

(54) ELECTRONIC THERMOSTAT

(75) Inventors: George Moser, Brighton, MI (US); Adam Ostapowicz, Westland, MI (US)

Correspondence Address: HARNESS, DICKEY & PIERCE, P.L.C., P.O. BOX 828, BLOOMFIELD HILLS, MI, 48303, US

(73) Assignee: EDC AUTOMOTIVE, LLC, AUBURN HILLS, MI (US)

(21) Appl. No.: 12/759,226

(22) Filed: Apr. 13, 2010

Related U.S. Application Data
(63) Continuation-in-part of application No. 11/793,183, filed on Jun. 14, 2007.
(60) Provisional application No. 60/637,085, filed on Dec. 20, 2004.
(60) Provisional application No. 60/663,794, filed on Mar. 21, 2005.
(60) Provisional application No. 60/690,673, filed on Jun. 16, 2005.
(60) Provisional application No. 60/690,672, filed on Jun. 16, 2005.

(51) Int. Cl. G05D 23/02

(52) U.S. Cl. 236/93 R

(57) ABSTRACT

A thermostat includes a housing defining a fluid path therethrough. The thermostat further includes a valve plate for selectively sealing an opening in the fluid path for opening and closing the fluid path. The valve plate is mounted within the fluid path for rotation about a pivot axis extending generally perpendicular to the flow of fluid through the housing. The valve plate is configured and disposed within the fluid path such that fluid pressure against a first portion of the valve plate creates a first torque and fluid pressure against a second portion of the valve plate creates a second torque. The first and second torques substantially cancel each other out such that a net torque generated by the fluid pressure on the valve plate is neglible.

### CROSS-REFERENCE TO RELATED APPLICATIONS

The application is a continuation-in-part of U.S. Ser. No. 11/793,183 filed Jun. 14, 2007, which claims priority to PCT International Application No. PCT/US05/45392 filed Dec. 14, 2005, which claims the benefit of U.S. Provisional Application Nos. 60/637,085 filed Dec. 20, 2004; 60/663,794 filed Mar. 21, 2005; 60/690,672 filed Jun. 16, 2005; and 60/690,673 filed Jun. 16, 2005. The disclosures of the above applications are incorporated herein by reference.

### FIELD

The present invention generally relates to an electronically controlled thermostatic valve and more particularly, to a vehicular thermostat that controls the cooling circuit of a vehicle.

### DISCUSSION

This section provides background information related to the present disclosure which is not necessarily prior art.

Internal combustion engines conventionally include a coolant pump that is typically driven from the engine. The coolant pump circulates coolant through the engine and to a radiator which extracts heat from the coolant and releases it to the atmosphere. A thermostat is used to allow the coolant to flow through the radiator when cooling is required. When the coolant is cold, the thermostat does not allow the coolant to reach the radiator, and the coolant is recirculated through the engine.

A conventional thermostat employs a heat motor in the form of a wax element to open or close a poppet valve. It is desirable that all coolant flow be circulated within the engine until the engine has reached a predetermined temperature. The valve seat is closed to accomplish this circulation. After the predetermined temperature is reached, the heat motor starts to open the valve seat that allows coolant flow to the radiator until it is fully open.

State of the art thermostats have numerous shortcomings. One of the main shortcomings is that conventional wax controlled thermostats are only responsive to the coolant temperature. In reality, it would be desirable to have a thermostat able to respond to other parameters, such as the actual temperature of the engine block (which is not always and not instantly directly proportional to the temperature of the coolant), the temperature of the cylinder head, the degree of acceleration of the vehicle as measured by the depression of the gas pedal, (which can be a predictor of a sudden upcoming heavy heat load), etc. A smart thermostat with a computer interface could sense multiple parameters and manage the cooling process more efficiently, preventing temperature fluctuations that negatively affect the durability of the engine.

A further disadvantage of wax thermostats is a notorious lack of reliability, which has made them one of the most well-known failure modes for vehicle users. Failure of the wax element, typically due to wax leakage out of the wax capsule, is still a relatively common occurrence that can cause the engine to overheat with potentially catastrophic consequences for the engine.

Accordingly, there remains a need in the pertinent art for a thermostat that overcomes the above disadvantages.

### SUMMARY

This section provides a general summary of the disclosure, and is not a comprehensive disclosure of its full scope or all of its features.

According to one aspect, the present teachings provide an automotive thermostat to control the flow of a fluid. The thermostat includes a housing defining a fluid path therethrough. The thermostat further includes a valve plate for selectively sealing an opening in the fluid path for opening and closing the fluid path. The valve plate is mounted within the fluid path for rotation about a pivot axis extending generally perpendicular to the flow of fluid through the housing. The valve plate is configured and disposed within the fluid path such that fluid pressure against a first portion of the valve plate creates a first torque and fluid pressure against a second portion of the valve plate creates a second torque. The first and second torques substantially cancel each other out such that a net torque generated by the fluid pressure on the valve plate is neglible.

According to another aspect, the present teachings provide a thermostat including a housing defining a fluid path therethrough. A flange is disposed in the fluid path and defines a plurality of selectively controlled openings that allow fluid to flow along the fluid path. A valve mechanism includes a corresponding plurality of valve members for selectively sealing the plurality of openings. The valve mechanism is mounted within the fluid path for rotation about a pivot axis extending generally perpendicular to the flow of fluid through the housing. The valve members are configured and disposed within the fluid path such that the fluid pressure against a first portion of the valve mechanism creates a first torque and fluid pressure against a second portion of the valve mechanism creates a second torque. The first and second torques substantially cancel each other out such that a net torque generated by the fluid pressure on the valve mechanism is neglible.

According to still yet another aspect, the present teachings provide an automotive thermostat to control the flow of a fluid. The thermostat includes a housing defining a fluid path therethrough. A flange is disposed in the fluid path and defines first and second selectively controlled openings that allow fluid to flow along the fluid path. A valve mechanism includes a hub mounted within the fluid path for rotation about a pivot axis extending generally perpendicular to the flow of fluid through the housing and first and second valve plates carried by the hub for selectively sealing the first and second openings, respectively. The first and second valve plates are configured and disposed within the fluid path such that fluid pressure against the first valve plate creates a first torque and fluid pressure against the second valve plate creates a second torque. The first and second torques substantially cancel each other out such that a net torque generated by the fluid pressure on the first and second valve plates is neglible. A computer controllable actuator rotates the valve mechanism about the pivoting axis for opening and closing the fluid path.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a top view of an automotive thermostat constructed in accordance with the present teachings.

FIG. 2 is a cross-sectional view taken through a portion of the automotive thermostat of FIG. 1, illustrating the thermostat in a closed condition.

FIG. 3 is another cross-sectional view taken through a portion of the automotive thermostat of FIG. 1, the thermostat illustrated in an open condition.

FIG. 4 is a top view of another automotive thermostat constructed in accordance with the present teachings.

FIG. 5 is a cross-sectional view taken through a portion of the automotive thermostat of FIG. 4, the thermostat shown in a closed condition.

FIG. 6 is a cross-sectional view similar to FIG. 5, illustrating the thermostat in an open condition.

FIG. 7 is a cross-sectional view taken along the line 7-7 of FIG. 4.

FIG. 8 is a top view of the automotive thermostat of FIG. 4, showing one of the external sealing methods of the present teachings.

Corresponding reference numerals indicate corresponding parts throughout the several views of the drawings. The various views are drawn to scale.

### DETAILED DESCRIPTION OF VARIOUS ASPECTS

Example embodiments will now be described more fully with reference to the accompanying drawings.

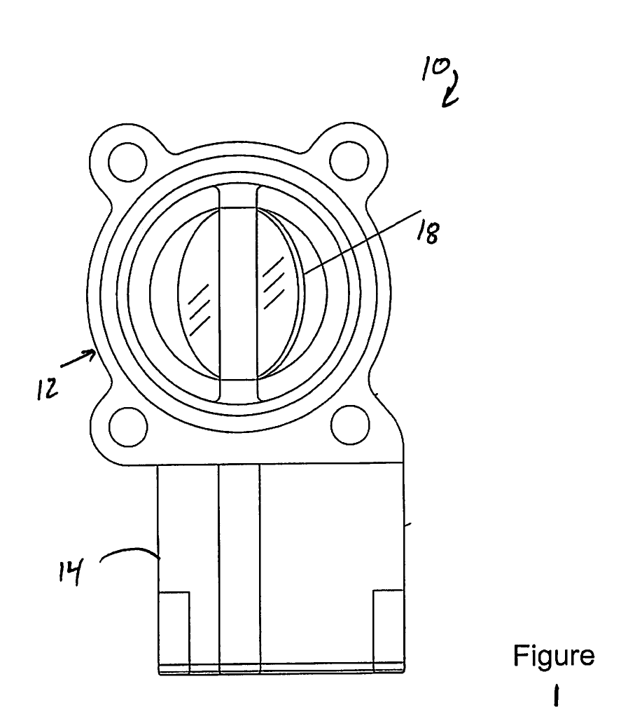

With initial reference to FIGS. 1 through 3, a thermostat in accordance with the present teachings is illustrated and identified at reference character 10. In one particular application, the thermostat 10 is particularly adapted for an automotive application. For this reason, the thermostat 10 may be referred herein as an automotive thermostat. Those skilled in the art, however, will appreciate that the present teachings may be adapted for other applications.

As illustrated, the thermostat 10 may be a single aperture thermostat. The thermostat 10 may generally include a thermostat housing 12 and an actuator portion 14 attached to the housing 12. The housing 12 may be secured to the actuator portion 14 in any manner well known in the art. Suitable gaskets or other structure may be provided to ensure a fluid tight connection.

The actuator portion 14 may include an electro-mechanical actuator (not particularly shown) for controlling the thermostat 10. It will be understood that operation of the electromechanical actuator is conventional insofar as the present teachings are concerned to the extent not otherwise described herein. Briefly, the electromechanical actuator may include, for example, a rotary solenoid, a linear solenoid with a crank mechanism to create rotation, an electrical motor, a servomotor, a stepper motor, a vacuum motor or another mechanism to provide rotation of the valve plate 18.

The housing 12 may define a fluid path having a single aperture or opening 16. In the particular application illustrated, the fluid may be coolant. In other applications, for example, the fluid may be refrigerant fluid or oil. The housing 12 may incorporate a flange 22 that separates cavity 24 that is open to the engine and the outside of housing 26 that is open to the radiator.

The aperture 16 may be gated by valve mechanism in the form of a single valve or valve plate 18. The valve plate 18 may be rotatable coupled to the housing 12 by a pivot shaft 20. The pivot shaft 30 may define a pivot axis. The pivot axis may extend generally perpendicular to the flow of fluid through the housing 12.

The valve plate 18 may be sized and configured to conform to the aperture 16 of the housing 12. The valve plate 18 may be symmetrical about the pivot axis defined by the pivot shaft 30. In the embodiment illustrated, the valve plate 18 may be generally circular such that the portions of the valve plate on opposite sides of the pivot axis are each generally in the shape of a half circle.

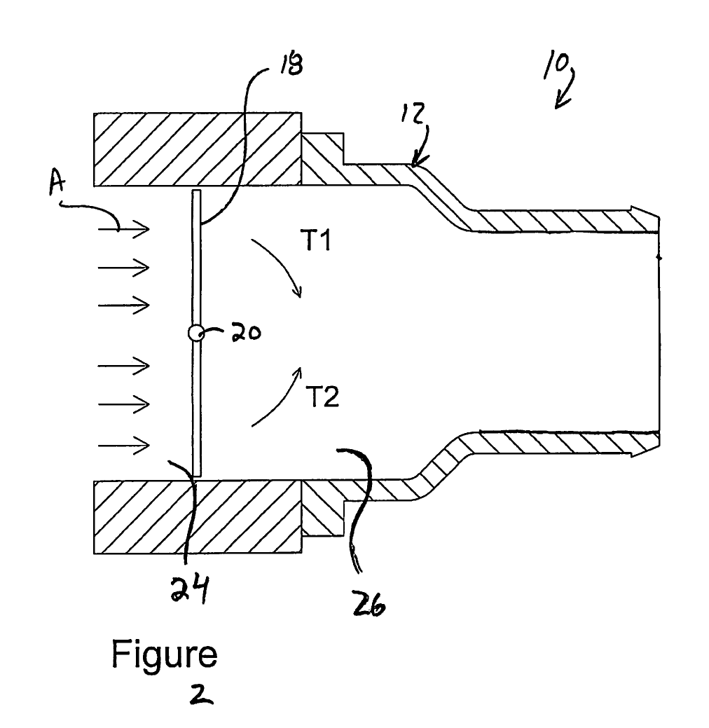

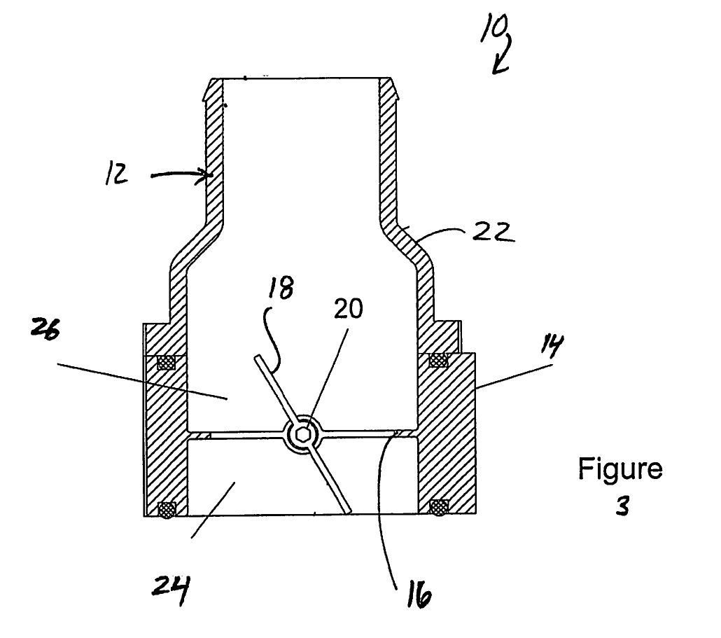

The valve plate 18 may be controlled by the actuator to move between a closed position for preventing the flow of fluid through the housing 12 and an open position permitting the flow of fluid through the housing 12. When the valve plate 18 is in its closed position (as shown in FIG. 2, for example), the thermostat is in a closed condition. Conversely, when the valve plate 18 is in its open position (as shown in FIG. 3, for example), the thermostat is in a closed condition.

With particular reference to the cross-sectional view of FIG. 2, the pivot axis of the valve plate 18 is centered so as to achieve a balance of pressure. In this manner, the net torque necessary to rotate the valve plate 18 is very low, because the fluid pressure generates counteracting torques that cancel each other out. The flow of fluid or coolant is represented in FIG. 2 by the arrows A. The coolant flow creates a pressure against the valve plate 18. Explaining further, the coolant flow pushes against the valve plate 18 and generates a clockwise torque T1 on the upper portion of the valve and counter-clockwise torque T2 on the lower portion of the valve. Because the pressure is the same, the resulting torques are equal in magnitude and can be represented as follows:

T1=−T2,

and therefore the net torque is

Tnet=T1+T2=0.

In practice, the net torque may not be exactly zero due to turbulence, small temperature gradients, etc. The net value, however, can be expected to always be a very small value that approaches zero. This balanced condition is differs from the typical conventional axial thermostats, which have to overcome the full pressure of the fluid or coolant. The torque canceling property of the present teachings essentially renders the thermostat 10 pressure-insensitive and allows the thermostat 10 to be controlled by a relatively small and cost-effective actuator for purposes of moving the valve plate 18. The actuator does not have to overcome any significant coolant pressure. Rather, it only needs to overcome friction at the bearings and seals of the shaft 20.

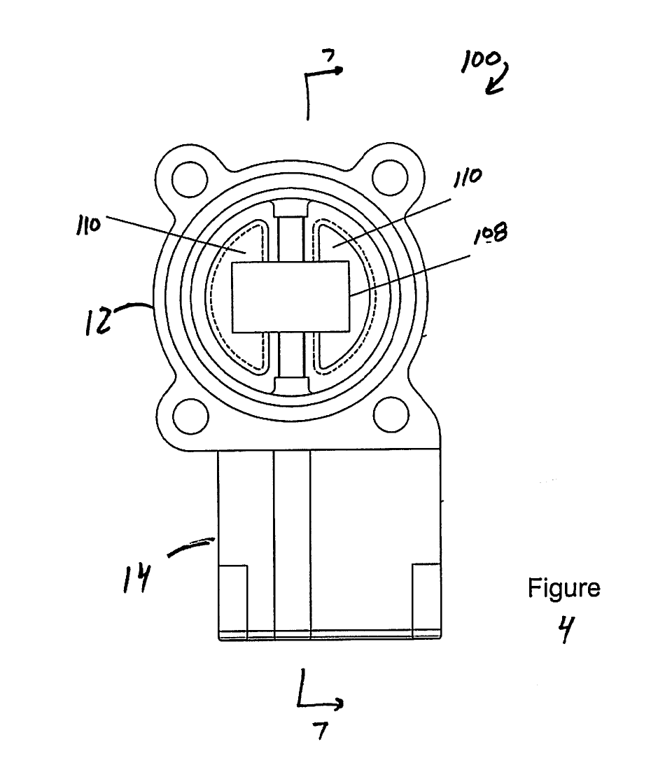

Turning to FIGS. 4 through 8, another thermostat in accordance with the present teachings is illustrated and generally identified at reference character 100. Again, in the thermostat 100 may be particularly adapted for use in an automotive application. More particularly, the thermostat 100 may be used to control the flow of coolant between a engine of the vehicle and a radiator of the vehicle. The present teachings, however, may be adapted for other applications. Given the similarities between the thermostat 100 and the thermostat 10, like reference characters will be used to identify similar elements throughout the various drawings.

The thermostat 100 differs from the thermostat 10 in that multiple openings 102 are provided within the fluid path extending through the housing 12. The multiple apertures 102 may be defined within a flange 104. In the particular embodiment illustrated, the flange 104 defines first and second apertures 102 in the fluid path of the housing 12.

The apertures 102 may be gated by a common valve mechanism 106. The valve mechanism 106 may include a hub or armature 108 and a corresponding plurality of valve plates 110 carried by the armature 108. The valve mechanism 106 may be rotatable coupled to the housing 12 by a pivot shaft 112. The valve plates 110 may be secured to the armature 108 in any well known manner and may be sized and configured to conform to the aperture 102 of the housing 12.

The valve plates 110 may be positioned on opposite sides of the flange 104. As shown in the drawings, one of the valve plates 110 may be disposed on the side of the flange 104 proximate the engine and the other of the valve plates 110 may be disposed on the side of the flange 104 proximate the radiator. One of the arms of the armature 108 may extend through one of the apertures 102.

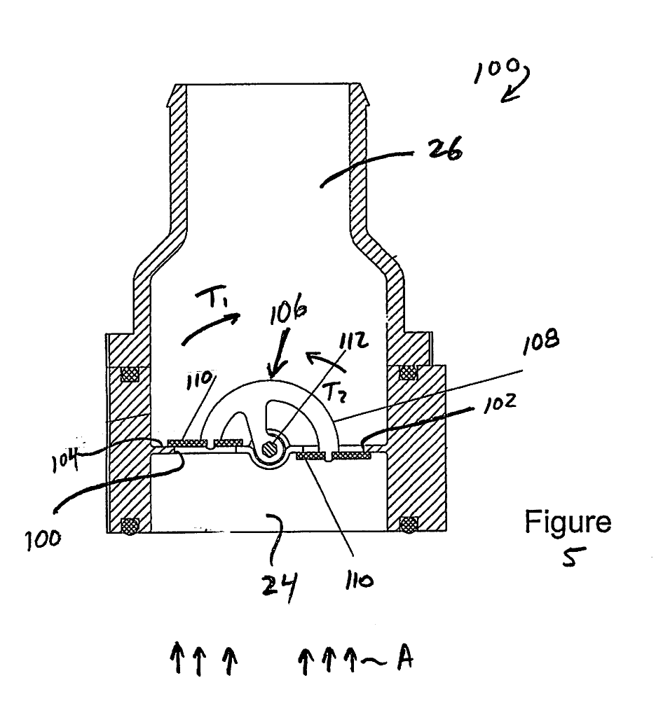

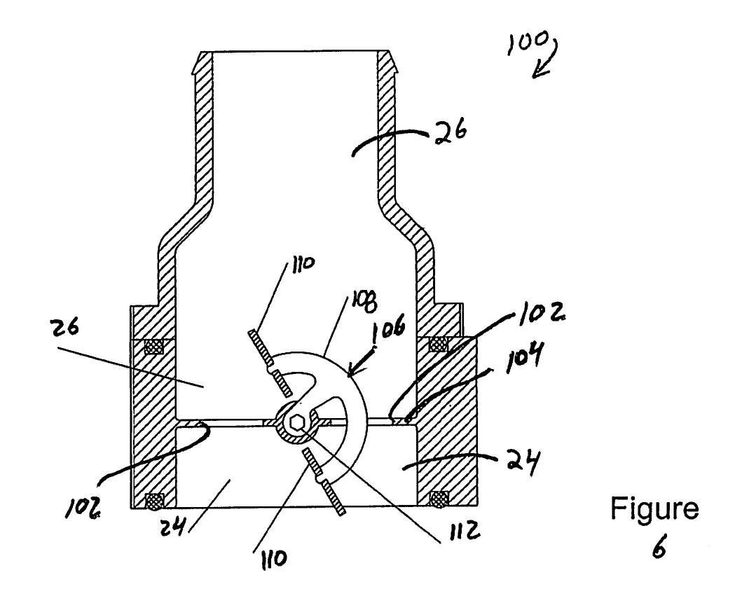

The valve mechanism 106 may be controlled by an actuator 114 to move between a closed position for preventing the flow of fluid through the housing 12 and an open position permitting the flow of fluid through the housing 12. When the valve mechanism 106 is in its closed position (as shown in FIG. 5, for example), the thermostat is in a closed condition. Conversely, when the valve mechanism 106 is in its open position (as shown in FIG. 6, for example), the thermostat 100 is in a closed condition.

With particular reference to the cross-sectional view of FIGS. 5 and 6, the pivot axis defined by the shaft 112 is centered so as to achieve a balance of pressure. Additionally, the valve plates 110 close calculated equivalent apertures. As a result, the net torque necessary to rotate the valve mechanism 106 is very low because the fluid pressure generates counteracting torques that cancel each other out. The flow of fluid or coolant is represented in FIG. 5 by the arrows A. The coolant flow creates a pressure against the valve plates 110. Explaining further, the coolant flow pushes against one of the valve plates 110 and generates a clockwise torque T1 and pushes on the other of the valve plates to create a counter-clockwise torque T2. As above, T1=−T2, and, therefore, the net torque is:

Tnet=T1+T2=0.

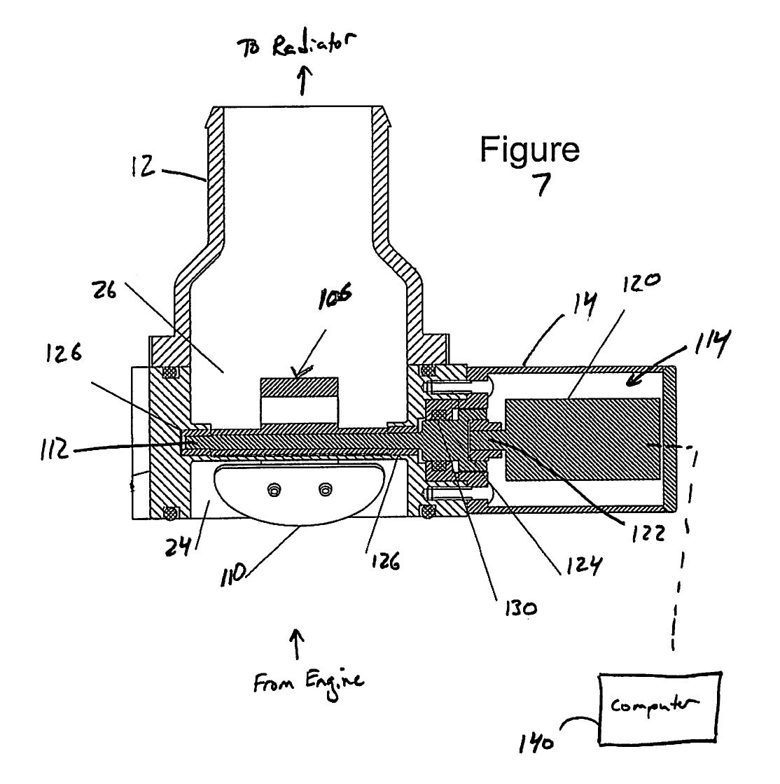

FIG. 7 shows an additional cross-section of the second preferred embodiment of the present invention and further details the actuator 114. The actuator 114 include a motor 120 having an output 122 coupled to the shaft 112 that is supported by bearings 126. As illustrated, the bearings 126 may be located at opposite ends of the axis of the shaft 112 through an interference fit. Alternatively, they may be attached with screws, rivets, or in an other manner well known in the art. In between the bearings 126, the hub 108 is attached to shaft 112. One of the valve plates 110 carried by the hub 108 is shown and FIG. 7 in the open position while the other valve plate 110 is not visible. Also shown in this figure is a seal pack 130 inserted into housing and circumscribing the shaft 112.

The actuator 114 may be controlled by a computer 140 (see FIG. 7). The computer 140 may be an on-board computer. The computer may direct the motor 120 of the actuator 114 to open and close the valve mechanism 106. As such, the thermostat 100 is able to respond to vehicle operating parameters other than the temperature of the fluid/coolant. For example, the computer 140 may control the thermostat 100 as a function of one or more of the following: the actual temperature of the engine block (which is not always and not instantly directly proportional to the temperature of the coolant), the temperature of the cylinder head, the degree of acceleration of the vehicle as measured by the depression of the gas pedal, (which can be a predictor of a sudden upcoming heavy heat load), etc. The thermostat 100 may interface with various vehicle sensors to more efficiently manage the cooling process, preventing temperature fluctuations that may negatively affect the durability of the engine. The actuator 114 is operable to provide a variable degree of angular opening of the thermostat 100 under the computer control and thereby provide a variable flow of fluid through the housing. In other applications, however, the device may be simplified and the thermostat may provide two basic positions, either open or closed.

An alternative embodiment of the invention provides a very low cost device by replacing the servomotor or stepper motor with a simple solenoid, which lacks the precise angle control of a servo or stepper motor but can still provide a computer controlled opening and closing of the thermostatic valve. That low-cost embodiment is basically an on-off device (open or closed) and cannot provide a controllable partial opening. However, in some cases for cost treasons that can be an acceptable compromise—which is not as sophisticated as a servo or stepper controlled thermostat, but still vastly superior to a wax thermostat.

Another embodiment of the invention provides an actuator that uses the vacuum available from the engine as the source of power to actuate the thermostatic valve. The vacuum actuator is basically a pressure container with a piston that can be displaced by the vacuum. The amount of vacuum is controlled by a vacuum valve, which under computer control allows a certain degree of negative pressure to develop inside the pressure container (for instance through controlled successive vacuum pulses). Instead of a piston it is also possible to use a shaft with a diaphragm or other similar pressure-responsive mechanisms. This embodiment can also provide a very cost-effective solution.

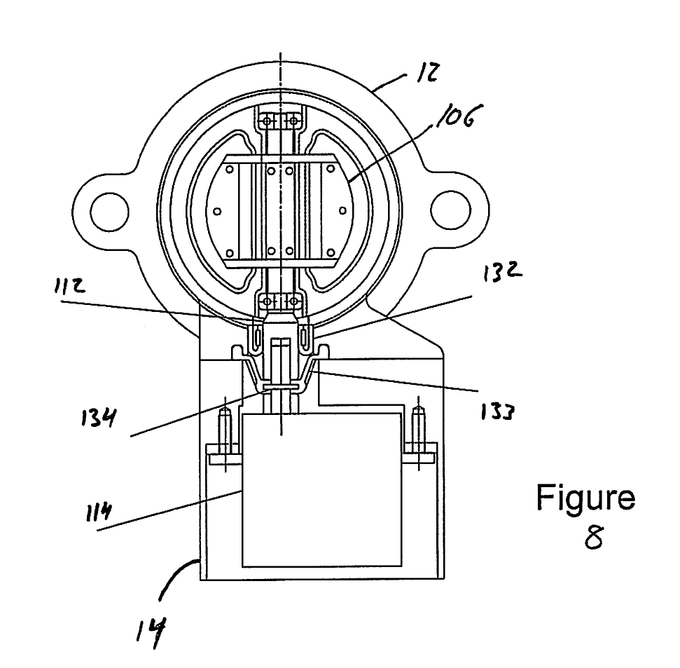

The top view of FIG. 8 further illustrates a seal pack 130 and a redundant sealing method in accordance with the present teachings. The redundant sealing method may include diaphragm 133 and a coupling insert 134 that is positioned between shaft 112 and the electro-mechanical actuator 114. The diaphragm 133 may allow significant shaft rotation while completely preventing leaks and withstanding pressure. The diaphragm 133 is not subject to the typical wear of a conventional dynamic seal because it acts in torsion, twisting along with the shaft rather than allowing the shaft to rotate and slide inside the seal. That is possible in this case because of the limited and controlled angle of rotation of the shaft.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. An automotive thermostat to control the flow of a fluid, the thermostat comprising:
a housing defining a fluid path therethrough; and
a valve plate for selectively sealing an opening in the fluid path for opening and closing the fluid path, the valve plate mounted within the fluid path for rotation about a pivot axis extending generally perpendicular to the flow of fluid through the housing, the valve plate configured and disposed within the fluid path such that the fluid pressure against a first portion of the valve plate creates a first torque and fluid pressure against a second portion of the valve plate creates a second torque;
whereby the first and second torques substantially cancel each other out such that a net torque generated by the fluid pressure on the valve plate is neglible.

2. The automotive thermostat of claim 1, further comprising a computer controllable actuator for rotating the pivoting valve plate about the pivoting axis.

3. The automotive thermostat of claim 1, wherein the fluid is engine coolant.

4. The automotive thermostat of claim 1, wherein the actuator is a vacuum actuator that uses engine vacuum to control the opening and closing of the thermostat.

5. The automotive thermostat of claim 1, wherein the actuator is operable to provide a variable degree of angular opening of the thermostat under computer control, thereby providing a variable flow of fluid.

6. The automotive thermostat of claim 1, wherein the valve plate is generally circular.

7. The automotive thermostat of claim 1, wherein the first portion and second portions of the valve plate are each generally in the shape of a half circle.

8. The automotive thermostat of claim 1, wherein the first portion and second portions of the valve plate have substantially equal surface areas exposed to the flow of fluid through the fluid path.

9. The automotive thermostat of claim 1, wherein the valve plate is substantially symmetrical about the pivot axis.

10. An automotive thermostat to control the flow of a fluid, the thermostat comprising:
a housing defining a fluid path therethrough;
a flange disposed in the fluid path and defining a plurality of selectively controlled openings that allow fluid to flow along the fluid path; and
a valve mechanism including a corresponding plurality of valve members for selectively sealing the plurality of openings, the valve mechanism mounted within the fluid path for rotation about a pivot axis extending generally perpendicular to the flow of fluid through the housing, the valve members configured and disposed within the fluid path such that the fluid pressure against a first portion of the valve mechanism creates a first torque and fluid pressure against a second portion of the valve mechanism creates a second torque;
whereby the first and second torques substantially cancel each other out such that a net torque generated by the fluid pressure on the valve mechanism is neglible.

11. The automotive thermostat of claim 10, wherein the flange includes a first side and a second side, at least a first valve member of the plurality of valve members disposed proximate the first side and at least a second valve member of the plurality of valve members disposed proximate the second side.

12. The automotive thermostat of claim 11, wherein the valve mechanism further includes a hub mounted for rotation about the pivot axis and carrying the valve members.

13. The automotive thermostat of claim 12, wherein rotation of the hub about the pivot axis in a first direction moves the at least first and second valve members towards the first and second sides of the flange, respectively, and rotation of the hub member about the pivot axis in a second, opposite direction, moves the at least first and second valve members away from the first and second sides of the flange.

14. An automotive thermostat to control the flow of a fluid, the thermostat comprising:
a housing defining a fluid path therethrough;
a flange disposed in the fluid path and defining first and second selectively controlled openings that allow fluid to flow along the fluid path; and
a valve mechanism including a hub mounted within the fluid path for rotation about a pivot axis extending generally perpendicular to the flow of fluid through the housing and first and second valve plates carried by the hub for selectively sealing the first and second openings, respectively, the first and second valve plates configured and disposed within the fluid path such that fluid pressure against the first valve plate creates a first torque and fluid pressure against the second valve plate creates a second torque, the first and second torques substantially cancel each other out such that a net torque generated by the fluid pressure on the first and second valve plates is neglible; and
a computer controllable actuator for rotating the valve mechanism about the pivoting axis for opening and closing the fluid path.

15. The automotive thermostat of claim 14, wherein the fluid is engine coolant.

16. The automotive thermostat of claim 14, wherein the actuator provides a variable degree of angular opening of the thermostat under computer control, thereby providing a variable flow of fluid.

17. The automotive thermostat of claim 14, wherein the flange includes a first side and a second side, the first valve plate disposed proximate the first side and the second valve plate disposed proximate the second side.

18. The automotive thermostat of claim 17, wherein the hub includes a first and second arms, the first and second valve plates carried by the first and second arms.

19. The automotive thermostat of claim 18, wherein rotation of the hub about the pivot axis in a first direction moves the first and second valve plates toward the flange and rotation of the hub member about the pivot axis in a second, opposite direction, moves the first and second valve plates away from the flange.

20. The automotive thermostat of claim 18, wherein the second arm of the hub member extends through the second opening of the flange.
